(19) United States
(12) Patent Application Publication
(10) Pub. No.: US 2013/0152449 A1
(43) Pub. Date: Jun. 20, 2013

(54) IN-LINE REEL AND ROD ASSEMBLY

(71) Applicant: Timothy S. Makos, West Bend, WI (US)

(72) Inventor: Timothy S. Makos, West Bend, WI (US)

(21) Appl. No.: 13/594,243

(22) Filed: Aug. 24, 2012

Related U.S. Application Data
(60) Provisional application No. 61/575,819, filed on Aug. 30, 2011.

(51) Int. Cl. A01K 87/00; A01K 87/06

(52) U.S. Cl. CPC A01K 87/002; A01K 87/06
USPC 43/18.1 HR; 43/22

(57) ABSTRACT

An improved in-line reel and rod assembly has a reel body mounted to the end of a hollow rod blank with or without a handle mounted between them. The reel body is made up of a reel outer body and a reel inner body, which could be constructed as a unitary structure. The reel outer body holds the spool shaft, drag and drag knob. A spool is removable for quick access to the line and is over-sized for greater line capacity. A disc drag system provides detent micro-adjustment for the angler. The reel inner body is designed to guide the line from the reel spool into the rod blank and io to keep fishing line damage to a minimum when fighting a fish. A larger diameter spool is used to minimize line twist and holds more line. A spring bobber is integrated into the rod blank at its distal end.

This application claims the benefit and priority of U.S. Provisional Pat. No. 61/575,819 filed Aug. 30, 2011.

### FIELD OF THE INVENTION

This invention relates generally to items and accessories used by anglers in the sport of fishing. More particularly, it relates to a specific configuration of a fishing rod and reel combination or assembly.

### BACKGROUND OF THE INVENTION

In most types of sport fishing techniques, a fishing rod is used with line and some sort of artificial lure or live bait that is placed into a body of water with the hope that a lurking fish will “take” the lure or bait. The lure or bait is attached to a line and the line, in turn, is typically attached to a reel and the reel is anchored to the fishing rod.

This inventor is aware of one style of a rod and reel combination which is a reel that is built in or attached to the end of a hollow rod blank. With this style, the line is spooled onto the reel and then fed through the rod blank at a point nearest the angler and out the opposite end at the distal point of the rod blank furthest from the angler. In the experience of this inventor, most of the reels used for this type of combination are very simple but do not give the user a drag mechanism to help fight bigger fish. Further, they do not hold a substantial amount of line because the spools are usually very small in diameter. The small diameter reel has another drawback in that it causes the line to have a tendency to “coil” which then causes the lure, such as an artificial “fly,” to spin in the water.

### SUMMARY OF THE INVENTION

In view of the foregoing, the improved in-line reel and rod of the present invention takes a particular reel design and incorporates it into a reel body that mounts to the end of a hollow rod blank with a handle mounted between the reel and the rod blank. That is, the reel portion is mounted and positioned as the butt of the rod. In the present invention and its preferred embodiment, the reel body is made up of two pieces or portions—a reel outer body and a reel inner body. The reel outer body holds the spool shaft, drag and drag knob. The reel outer body and the reel inner body could, in the present invention, be constructed as a single structure.

The spool provided in the preferred embodiment is easily removable for quick access to the line and is over-sized for greater line capacity. Further, the disc drag system provides detent micro-adjustment for the angler. The reel inner body is a cylindrical piece that fits into the end of the reel outer body. The rod blank mounts inside the inner body and the rod handle mounts on top of the inner body. The inner body includes structural features that allow it to act as a line guide to aid in guiding the line from the reel spool into the rod blank. This keeps fishing line damage to a minimum when fighting a fish. A spring bobber is integrated into the io rod blank at its distal end to detect a fish strike.

The new reel design solves all the problems of the existing reels used with this type of rod blank. In short, it gives the angler a drag for fighting fish, larger diameter spool for minimizing line twist, and holds more line. The reel of the present invention could also be used for ice fishing as well as dock fishing. The foregoing and other features of the present invention will be apparent from the detailed description that follows.

### BRIEF DESCRIPTION OF THE DRAWINGS

FIG. 1 is a top and right side perspective view of a preferred embodiment of the in-line rod and reel that is constructed in accordance with the present invention.

FIG. 2 is an enlarged view of the right side proximal portion of the in-line rod and reel which is similar to the view shown in FIG. 1 and showing the details of the right side of the device.

FIG. 3 is an enlarged view of the left side proximal portion of the in-line rod and reel which is similar to the view shown in FIG. 2.

FIG. 4 is cross-sectioned right side elevational view of the in-line rod and reel shown above.

### DETAILED DESCRIPTION

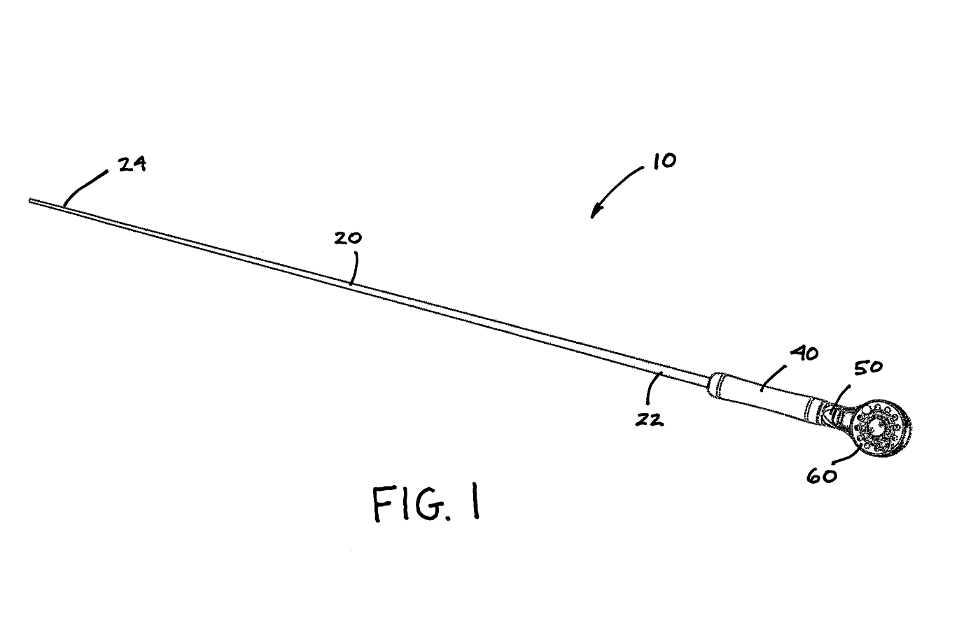

Referring now to the drawings in detail wherein like numbers represent like elements throughout, FIG. 1 illustrates a perspective view of the preferred embodiment of the in-line rod and reel device, generally identified 10. The device 10 comprises a rod blank 20, a handle 40, a reel inner body 50 and a reel outer body 60. It is to be understood that the device 10 of the present invention could be configured without a handle 40. It is also to be understood that the device 10 of the present invention could comprise a composite reel inner body 50 and reel outer body 60, those bodies 50, 60 being constructed as a single unitary structure.

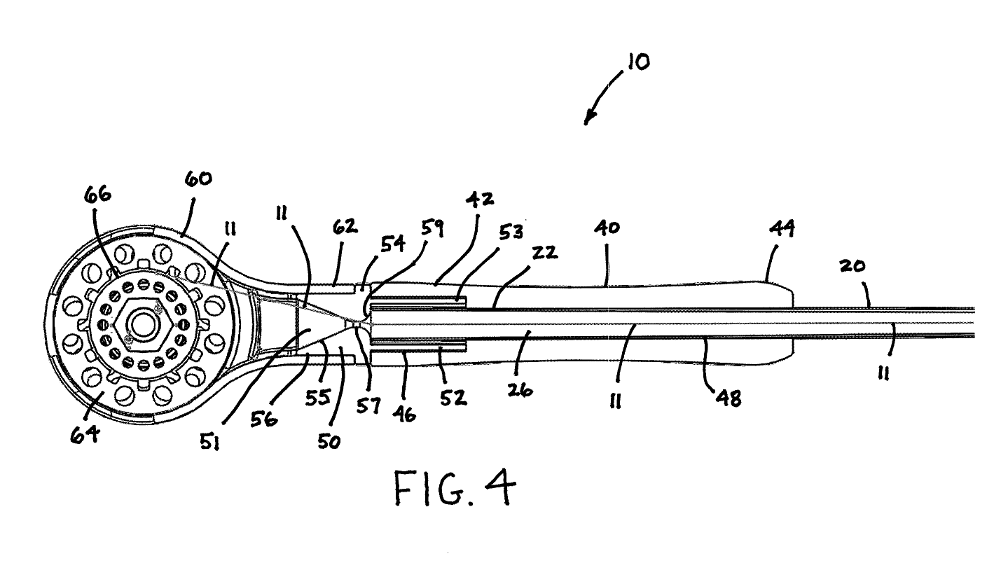

The rod blank 20 comprises a rearward rod blank portion 22 that is proximal to the angler and a forward rod blank portion 24 that is distal to the angler. The rod blank 20 is a hollow structure. See FIG. 4. That is, a centrally-disposed rod blank aperture 26 forms an unobstructed cylindrical continuum through the entire length of the rod blank 20, the rod blank aperture 26 being provided such that the fishing line 11 can freely pass through the rod blank 20. It is to be understood that the forward rod portion 24 could include an integrated spring bobber or tip insert (not shown) to protect the line 11 from being damaged by the rod blank 20 at the forward rod blank portion 24. It would also be within the scope of the present invention to provide a rod blank 20 which comprises telescoping sections (also not shown) to allow the rod blank 20 to be collapsed for storage.

Referring again to FIG. 4, it shows how the rearward rod blank portion 22 is surrounded by and secured within the rod handle 40. The rod handle 40 comprises a rearward portion 42 and a forward portion 44. A rearward and centrally-disposed cylindrical aperture 46 is formed within the rearward portion 42 of the handle 40. A forward and centrally-disposed cylindrical aperture 48 is formed within the forward portion 44 of the handle 40. in the device of the present invention, the inside diameter of the forward rod handle aperture 48 is dimensioned to be approximately the same as the outside diameter of the rearward portion 22 of the rod blank 20. The inside diameter of the rearward rod handle aperture 46 is dimensioned to be greater that the outside diameter of the forward rod handle aperture 48. The reason for this is that the inside diameter of the rearward rod handle aperture 46 is dimensioned to receive a portion of the next element, the reel inner body 50, within it. Again, it is to be understood that the device 10 of the present invention could be configured without a handle 40.

FIG. 4 also shows that the reel inner body 50 comprises a generally cylindrical and symmetrically-shaped structure having a forward portion 52, a central portion 54 and a rearward portion 56. The cylindrical forward portion 52 is that portion of the reel inner body 50 that is received within the rearward rod handle aperture 46 as described above. The forward portion 52 of the reel inner body 50 further includes a generally cylindrical aperture 53 into which the rearward portion 22 of the rod blank 20 can be inserted. In the configuration where the device 10 is provided without a handle 40, the rearward portion 22 of the rod blank 20 would be fully supported by the cylindrical aperture 53 of the forward portion 52 of the reel inner body 50. As shown, however, the central portion 54 effectively provides a spacer between the forward portion 62 of the reel outer body 60 and the rearward portion 42 of the rod handle 40. The rearward portion 56 of the reel inner body 50 comprises a substantially cylindrical outer surface 51 over which a portion of the reel outer body 60 can be disposed.

Significantly, the reel inner body 50 further comprises an inner line aperture 51, through which aperture 51 the line 11 is intended to pass. In the cross-sectioned FIG. 4, it will be seen that the inner line aperture 51 of the reel inner body 50 comprises an inwardly-tapered rearward line aperture portion 55, a central line aperture portion 57 and an outwardly-tapered forward line aperture portion 59. Each portion 55, 57, 59 of the line aperture 51 is a smooth finished surface which allows the line 11 to be io guided into and out of the aperture without any damage to the line 11. The central line aperture portion 57 also keeps the line “centered” within the rod blank 20 and allows the line 11 to easily feed down the rod blank aperture 26.

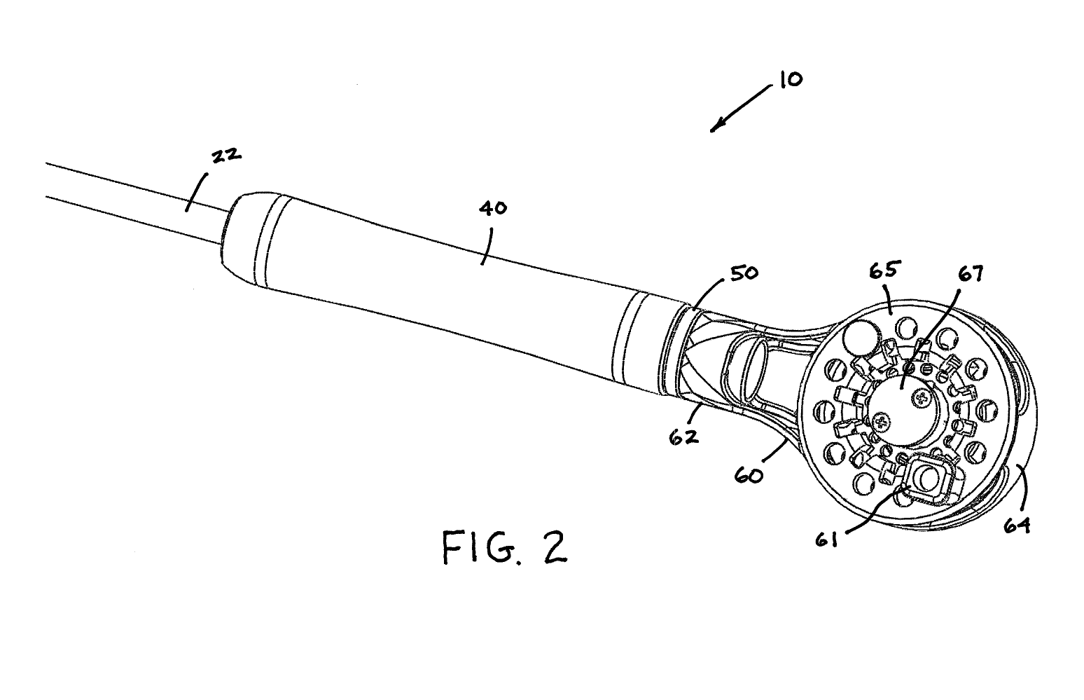

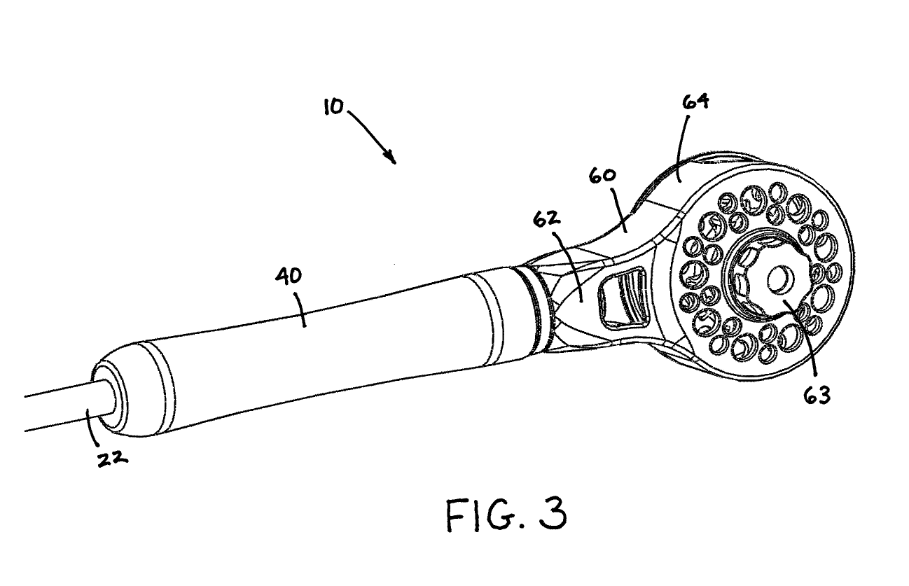

The reel outer body 60 comprises a forward and axially cylindrical forward portion 62 as mentioned above. See also FIGS. 2 and 3. The reel outer body 60 further comprises a rearward reel housing 64 within which a line spool 66 is housed. The reel housing 64 further comprises a reel housing cover 65 with fastening means 67. The reel outer body housing 64 further comprises a reel handle 61 and a drag adjustment knob 63 for a drag mechanism (not shown) having a disc drag system with detent micro adjustment functionality. Further the fastening means 67 allows for easy removal of the line spool 66 for quick access to the line 11. In the preferred embodiment, the spool 66 is over sized to allow for greater line capacity. As alluded to previously, the device 10 of the present invention could comprise a composite reel inner body 50 and reel outer body 60, those bodies 50, 60 being constructed as a single unitary structure.

Based upon the foregoing, it will be seen that there has been provided a new and useful in-line reel and rod that takes a classic reel design and incorporates it into a reel body that mounts to the end of a hollow rod blank with a handle mounted about the reel and the rod blank. The reel portion is mounted and positioned at the butt of the rod and the reel body is made up of two parts, specifically a reel outer body and a reel inner body, although the reel outer body and the reel inner body could be configured as a single unitary structure. The reel outer body holds the spool shaft, drag and drag knob. In the present invention, the spool is easily removable for quick access to the line and is over-sized for greater line capacity. Further, the disc drag system provides detent micro-adjustment capabilities for the angler. The reel inner body includes structural features that allow it to act as a line guide to aid in guiding the line from the reel spool into the rod blank. This keeps fishing line damage to a minimum when fighting a fish. A spring bobber is integrated into the rod blank at its distal end to detect a fish strike. In short, the new in-line reel and rod design solves all the problems of the existing reels used with this type of rod blank. Specifically, it gives an angler a drag for fighting fish, larger diameter spool for minimizing line twist, and holds more line. The in-line reel and rod of the present invention could also be used for ice fishing as well as dock fishing and the rod blank could be configured as a telescoping structure. The in-line reel and rod can also be configured with or without the use of a handle structure.

The principles of this invention having been fully explained in connection with the foregoing, I hereby claim as my invention:

1. An in-line reel and rod assembly comprising:
a hollow rod blank, the hollow rod blank comprising a forward portion and a rearward portion;
a rod handle, the rod handle being disposed about the rearward portion of the hollow rod blank and comprising a rearward portion;
an reel inner body, the reel inner body comprising a forward portion and a rearward portion, the forward portion of the reel inner body being attached to the rearward portion of the rod handle and to the rearward portion of the rod blank; and
a reel outer body, the reel outer body comprising a forward portion that is attached to the rearward portion of the reel inner body.

2. The assembly of claim 1 wherein the reel inner body comprises a generally cylindrical and symmetrically-shaped structure and further comprises an inner line aperture.

3. The assembly of claim 2 wherein the inner line aperture of the reel inner body comprises an inwardly-tapered rearward line aperture portion, a central line aperture portion and an outwardly-tapered forward line aperture portion.

4. The assembly of claim 1 wherein the rod handle comprises a rearward and centrally-disposed cylindrical aperture and a forward and centrally-disposed cylindrical aperture, the diameter of the rearward aperture being dimensioned to be greater than the diameter of the forward aperture.

5. The assembly of claim 4 wherein the forward portion of the reel inner body comprises a cylindrically-shaped structure having a diameter that allows the forward portion of the reel inner body to fit into the rearward portion of the rod handle.

6. The assembly of claim 1 wherein the reel outer body further comprises a rearward reel housing.

7. The assembly of claim 6 wherein the assembly further comprises a reel housing cover and a fastening means.

8. The assembly of claim 7 wherein the assembly further comprises a spool of line contained within the reel housing and reel housing cover.

9. The assembly of claim 8 wherein the assembly further comprises a reel handle, a drag mechanism and a drag adjustment knob for detent micro adjustment functionality.

10. The assembly of claim 1 wherein forward portion of the rod blank further comprises an integrated spring bobber or tip insert.

11. The assembly of claim 1 wherein the reel inner body and the reel outer body are constructed as a single unitary structure.

12. An in-line reel and rod assembly that comprises:
an reel inner body, the reel inner body comprising a forward portion, a forward portion aperture and a rearward portion;
an reel outer body, the reel outer body comprising a forward portion that is attached to the rearward portion of the reel inner body; and
a hollow rod blank, the hollow rod blank comprising a rearward portion that is attached to the forward portion aperture of the reel inner body.

13. The assembly of claim 12 wherein the reel inner body comprises a generally cylindrical and symmetrically-shaped structure and further comprises an inner line aperture and wherein the inner line aperture of the reel inner body comprises an inwardly-tapered rearward line aperture portion, a central line aperture portion and an outwardly-tapered forward line aperture portion.

14. The assembly of claim 12 further comprising a rod handle, the rod handle being disposed about the rearward portion of the hollow rod blank and wherein the rod handle comprises a rearward and centrally-disposed cylindrical aperture and a forward and centrally-disposed cylindrical aperture, the diameter of the rearward aperture being dimensioned to be greater than the diameter of the forward aperture.

15. The assembly of claim 14 wherein the forward portion of the reel inner body comprises a cylindrically-shaped structure having a diameter that allows the forward portion of the reel inner body to fit into the rearward portion of the rod handle.

16. The assembly of claim 12 wherein the reel outer body further comprises a rearward reel housing.

17. The assembly of claim 16 wherein the assembly further comprises a reel housing cover and a fastening means.

18. The assembly of claim 17 wherein the assembly further comprises a spool of fishing line contained within the reel housing and reel housing cover.

19. The assembly of claim 18 wherein the assembly further comprises a reel handle, a drag mechanism and a drag adjustment knob for detent micro adjustment functionality.

20. The assembly of claim 12 wherein forward portion of the rod blank further comprises an integrated spring bobber or tip insert.

21. The assembly of claim 12 wherein the reel inner body and the reel outer body are constructed as a single unitary structure.
